(19) United States
(12) Patent Application Publication
(10) Pub. No.: US 2013/0166692 A1
(43) Pub. Date: Jun. 27, 2013

(54) METHOD AND APPARATUS FOR PROVIDING CROSS PLATFORM AUDIO GUIDANCE FOR WEB APPLICATIONS AND WEBSITES

(71) Applicants: Andy Tjin, Berlin (DE); Baik Hoh, San Jose, CA (US); Tochukwu Iwuchukwu, Mountain View, CA (US)

(72) Inventors: Andy Tjin, Berlin (DE); Baik Hoh, San Jose, CA (US); Tochukwu Iwuchukwu, Mountain View, CA (US)

(73) Assignee: Nokia Corporation, Espoo (FI)

(21) Appl. No.: 13/337,946

(22) Filed: Dec. 27, 2011

(51) Int. Cl. G06F 15/16

(52) U.S. Cl. 709/219

(57) ABSTRACT

An approach is provided for providing cross-platform audio guidance for web applications and websites. A media platform causes a concatenation of a media file associated with a web application into a concatenated media file. A media platform then determines to insert a buffer segment between the media files in the concatenated media file. A media platform thereafter causes a transmission of the concatenated media file to a web client based on an access of the web application by a web client. A web client then determines a request to activate a media file associated with the web application, wherein the media file is included in the concatenated media file. A web client further seeks a start time of the media file in the concatenated media file to initiate a playback of the media file.

### BACKGROUND

Service providers and device manufacturers (e.g., wireless, cellular, etc.) are continually challenged to deliver value and convenience to consumers by, for example, providing compelling network services. One area of interest has been the development of web applications and websites that automatically play media files (e.g., audio files) when loaded by a user of a mobile device (e.g., mobile phone). The World Wide Web Consortium (W3C) has developed a series of standards for application development, wherein Hyper Text Markup Language (HTML) version 5 (HTML5) is the cornerstone of such standards. By way of example, the ability to automatically play audio files is an important enabler for games. However, some mobile browsers (e.g., SAFARI on iOS) currently do not support the complete W3C specification in order to protect users from larger unwanted downloads. In addition, some mobile platforms and/or operating systems (e.g., ANDROID) currently have difficulties with seeking exact locations in a media file (e.g., an audio file and/or a video file). As a result, playing any part of a media file may result in a user not hearing or seeing the intended part of the media file. Therefore service providers and device manufactures face significant technical challenges in providing a service that allows users to seamlessly experience media associated with web applications and websites regardless of the mobile browser or mobile platform being utilized.

### Some Example Embodiments

Therefore, there is a need for an approach for providing cross-platform audio guidance for web applications and websites.

According to one embodiment, a method comprises causing, at least in part, a concatenation of one or more media segments, one or more media files, or a combination thereof associated with one or more web applications, one or more websites, or a combination thereof into at least one concatenated media file. The method also comprises determining to insert at least one buffer segment between the one or more media segments, the one or more media files, or a combination thereof in the at least one concatenated media file. The method further comprises causing, at least in part, a transmission of the at least one concatenated media file to a web client based, at least in part, on an access of the at least one web application, the at least one website, or a combination thereof.

According to another embodiment, an apparatus comprises at least one processor, and at least one memory including computer program code for one or more computer programs, the at least one memory and the computer program code configured to, with the at least one processor, cause, at least in part, the apparatus to cause, at least in part, a concatenation of one or more media segments, one or more media files, or a combination thereof associated with one or more web applications, one or more websites, or a combination thereof into at least one concatenated media file. The apparatus is also caused to determine to insert at least one buffer segment between the one or more media segments, the one or more media files, or a combination thereof in the at least one concatenated media file. The apparatus is further caused to cause, at least in part, a transmission of the at least one concatenated media file to a web client based, at least in part, on an access of the at least one web application, the at least one website, or a combination thereof.

According to another embodiment, a computer-readable storage medium carries one or more sequences of one or more instructions which, when executed by one or more processors, cause, at least in part, an apparatus to cause, at least in part, a concatenation of one or more media segments, one or more media files, or a combination thereof associated with one or more web applications, one or more websites, or a combination thereof into at least one concatenated media file. The apparatus is also caused to determine to insert at least one buffer segment between the one or more media segments, the one or more media files, or a combination thereof in the at least one concatenated media file. The apparatus is further caused to cause, at least in part, a transmission of the at least one concatenated media file to a web client based, at least in part, on an access of the at least one web application, the at least one website, or a combination thereof.

According to another embodiment, an apparatus comprises means for causing, at least in part, a concatenation of one or more media segments, one or more media files, or a combination thereof associated with one or more web applications, one or more websites, or a combination thereof into at least one concatenated media file. The apparatus also comprises means for determining to insert at least one buffer segment between the one or more media segments, the one or more media files, or a combination thereof in the at least one concatenated media file. The apparatus further comprises means for causing, at least in part, a transmission of the at least one concatenated media file to a web client based, at least in part, on an access of the at least one web application, the at least one website, or a combination thereof.

According to one embodiment, a method comprises determining a request, at a web client, to activate at least one media segment associated with at least one web application, at least one website, or a combination thereof, wherein the at least one media segment is included in at least one concatenated media file that is a concatenation of the at least one media segment, one or more other media segments, one or more media files, or a combination thereof with one or more buffer segments separating the at least one media segment, the one or more other media segments, the one or more media files, or a combination thereof. The method also comprises causing, at least in part, a seeking to a start time of the at least one media segment in the at least one concatenated media file to initiate a playback of the at least one media segment.

According to another embodiment, an apparatus comprises at least one processor, and at least one memory including computer program code for one or more computer programs, the at least one memory and the computer program code configured to, with the at least one processor, cause, at least in part, the apparatus to determine a request, at a web client, to activate at least one media segment associated with at least one web application, at least one website, or a combination thereof, wherein the at least one media segment is included in at least one concatenated media file that is a concatenation of the at least one media segment, one or more other media segments, one or more media files, or a combination thereof with one or more buffer segments separating the at least one media segment, the one or more other media segments, the one or more media files, or a combination thereof. The apparatus is also caused to cause, at least in part, a seeking to a start time of the at least one media segment in the at least one concatenated media file to initiate a playback of the at least one media segment.

According to another embodiment, a computer-readable storage medium carries one or more sequences of one or more instructions which, when executed by one or more processors, cause, at least in part, an apparatus to determine a request, at a web client, to activate at least one media segment associated with at least one web application, at least one website, or a combination thereof, wherein the at least one media segment is included in at least one concatenated media file that is a concatenation of the at least one media segment, one or more other media segments, one or more media files, or a combination thereof with one or more buffer segments separating the at least one media segment, the one or more other media segments, the one or more media files, or a combination thereof. The apparatus is also caused to cause, at least in part, a seeking to a start time of the at least one media segment in the at least one concatenated media file to initiate a playback of the at least one media segment.

According to another embodiment, an apparatus comprises means for determining a request, at a web client, to activate at least one media segment associated with at least one web application, at least one website, or a combination thereof, wherein the at least one media segment is included in at least one concatenated media file that is a concatenation of the at least one media segment, one or more other media segments, one or more media files, or a combination thereof with one or more buffer segments separating the at least one media segment, the one or more other media segments, the one or more media files, or a combination thereof. The apparatus also comprises means for causing, at least in part, a seeking to a start time of the at least one media segment in the at least one concatenated media file to initiate a playback of the at least one media segment.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-6, 13-16, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing cross-platform audio guidance for web applications and websites, according to one embodiment;

FIGS. 2A and 2B are diagrams of the components of a media platform and a web client, respectively, according to one embodiment;

FIG. 3 is a flowchart of the server side process for providing cross-platform audio guidance for web applications and websites, according to one embodiment;

FIG. 4 is a flowchart of the client side process for providing cross-platform audio guidance for web applications and websites, according to one embodiment;

FIG. 5 is a diagram of an example data flow as utilized in the processes of FIGS. 3 and 4, according to various embodiments;

FIG. 6 is a diagram of example user interfaces utilized in the processes of FIGS. 3 and 4, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for providing cross-platform audio guidance for web applications and websites are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

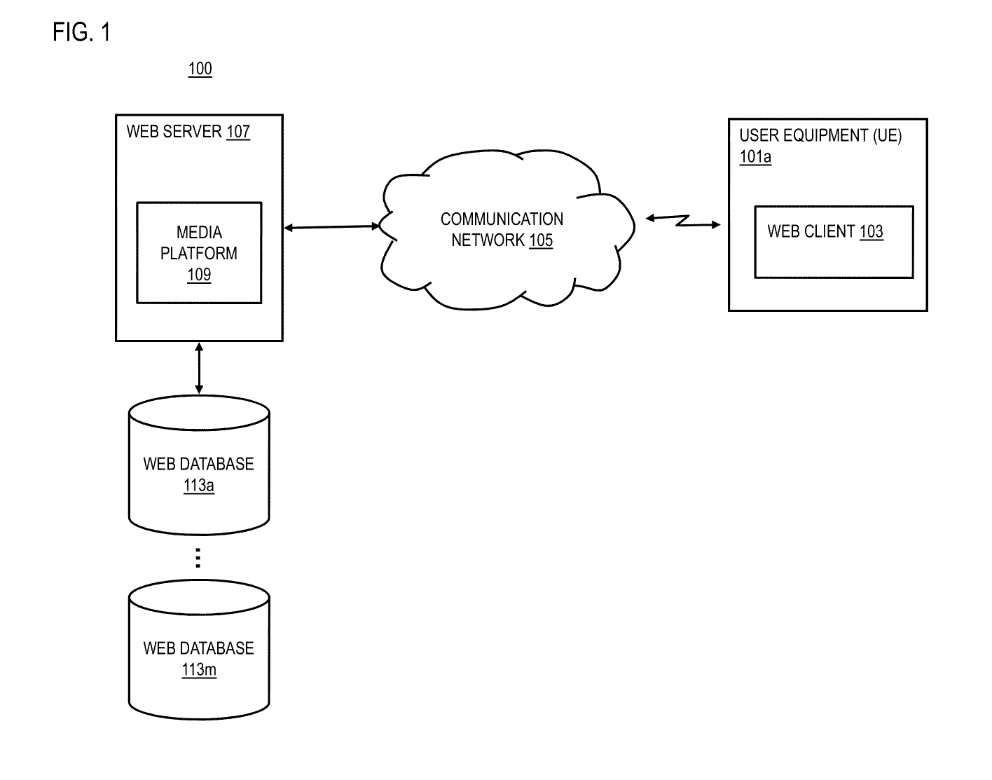

FIG. 1 is a diagram of a system capable of providing cross-platform audio guidance for web applications and websites, according to one embodiment. Modern web browsers including those used by mobile devices (e.g., a mobile phone) support a standard way of playing media files (e.g., audio files and video files) with HTML tags (e.g., audio tags) that have been specified by W3C in their HTML5 specification. More specifically, web applications and websites can include audio tags to refer to audio files. The audio described in the audio tags can programmatically be played to a user by utilizing a JavaScript application programming interface (API). According to the W3C specification standards, it should be possible to play as many audio instructions as a user likes utilizing a web application or a website. However, some mobile browsers (e.g., SAFARI on iOS) currently do not support the complete W3C specification standards. In particular, these mobile browsers do not allow audio files to be played by mere JavaScript programming. Moreover, in such browsers, an audio tag is not activated (e.g., preloading or playing) without a user interaction (e.g., pressing a button). This requirement prohibits web applications and websites from effectively offering audio guidance (i.e., automatically giving a user any kind of auditory instruction at a relevant point in time.) This prohibition is often detrimental with games and route navigation. In addition, some mobile platforms and/or operating systems (e.g., ANDROID) currently have difficulties seeking exact locations in a media file (e.g., an audio file and/or a video file). More specifically, mobile browsers running on the ANDROID mobile platform and/or operating system often experience bad timer accuracy, which makes it difficult for those mobile browsers to control audio tags in one or more media files (e.g., playing, stopping, and/or pausing the media files). As a result, playing any part of a media file may result in a user not hearing or seeing the intended portion of the media file.

To address this problem, a system 100 of FIG. 1 introduces the capability of providing cross-platform audio guidance for web applications and websites, according to one embodiment. More specifically, the system 100, on the server side, causes a concatenation (i.e., a stitching) of one or more media fragments (e.g., one or more media segments, one or more media files, or a combination thereof) associated with one or more web applications, one or more websites, or a combination thereof with at least one buffer segment (e.g., a period of audio silence or a period of blank video) between each of the one or more media fragments. In one embodiment, the system 100 can concatenate one or more media fragments on a situation-dependent basis or on a situation-independent basis. More specifically, the system 100 can concatenate one or more media fragments on an as needed basis and then transmit the one or more concatenated media fragments to a client based on one or more specific requests from the client. By way of example, the system 100 can enable a user to add his or her own instructions to the one or more concatenated media fragments so that the user can later hear a personalized audio guidance upon request (e.g., “Bob, do not park your car in front of my house, instead go to the nearest public parking.”). In another example, the system 100 can concatenate one or more media fragments in advance and then transmit the one or more concatenated media fragments to a client where they can be locally cached at the client for subsequent navigation requests.

In one embodiment, the one or more media fragments comprise one or more auditory instructions or one or more parts of one or more auditory instructions associated with one or more web applications, one or more websites, or a combination thereof. In addition, the media fragments may comprise one or more seekable file formats (e.g., MP3, Ogg, WAV, AAC, etc.). The system 100 also generates a time table file identifying the one or more media fragments in the concatenated media file along with their given start time and end time. The system 100 then transmits the time table file to a web client attempting to access the one or more web applications, the one or more websites, or a combination thereof.

In one embodiment, the system 100 determines the duration of at least one buffer segment based on the media playback seek accuracy associated with a web client, a media plugin associated with the web client, a web application being accessed by the web client, a website being accessed by the web client, or a combination thereof. The system 100 can also determine that the at least one buffer segment is generated with a constant duration (e.g., 250 ms or 500 ms), with a variable duration based on a function related to a playback position within the concatenated file (e.g., a linear function or a logarithmic function), or a combination thereof. In one embodiment, the system 100 can further differentiate the at least one buffer segment for respective ones of the one or more web applications, the one or more websites, or a combination thereof.

In one embodiment, the system 100, on the client side, determines a request to activate at least one media segment (e.g., an audio segment), at least one media file (e.g., an audio file), or a combination thereof contained in a concatenated media file associated with a web application (e.g., a navigation application), a website, or a combination thereof. By way of example, a web client may request to activate a media segment associated with a web application in order for a user of a mobile device (e.g., a mobile phone) to hear as well as read instructions, directions, or a combination thereof associated with the web application. The system 100 then utilizes the request to initiate a playback of the media segment in the concatenated media file. Next, the system 100 immediately pauses the playback of the concatenated media file (i.e., before a user is able to hear a sound or view an image) so that the system 100 can seek the specific start time of the requested media segment from the time table file associated with the concatenated media file. As a result of the initiation of the concatenated media file, the system 100 can now playback the one or more media segments, the one or more media files, or a combination thereof associated with the web application based on the at least one start time and at least one end time for the one or more media segments, the one or more media files, or a combination thereof.

As shown in FIG. 1, the system 100 comprises a user equipment (UE) 101 (e.g., a mobile handset) containing a web client 103 (e.g., a web browser) having connectivity to a web server 107 containing a media platform 109 via a communication network 105. The web server 107 is also connected to one or more web databases 113a-113n (also collectively referred to as web databases 113). In one embodiment, the web databases 113 may contain one or more HTML files, one or more media segments, one or more media files, or a combination thereof associated with one or more web applications, one or more websites, or a combination thereof. In addition, the web databases 113 may also contain one or more concatenated media files, one or more related time table files, and one or more buffer segments, all generated by the system 100. Both the media platform 109 and the web databases 113 may exist in whole or in part within the web server 107, or independently. In certain embodiments, the web server 107 may have connectivity to the web databases 113 via the communication network 105.

In one embodiment, from the server side perspective, the media platform 109 determines a request from a web client 103 of a UE 101 to access one or more web applications, one or more websites, or a combination thereof associated with one or more media segments, one or more media files, or a combination thereof. Based on this request, the media platform 109 causes a concatenation (i.e., a stitching) of the one or more media segments (e.g., audio segments), the one or more media files (e.g., audio files), or a combination thereof with at least one buffer segment (e.g., a period of audio silence) between the one or more media segments, the one or more media files, or a combination thereof. By way of example, the one or more media segments, the one or more media files, or a combination thereof can comprise one or more auditory instructions or one or more parts of one or more auditory instructions. In addition, the one or more media segments, the one or more media files, or a combination thereof may comprise one or more seekable file formats (e.g., MP3, Ogg, WAV, AAC, etc.). In one embodiment, the media platform 109 then generates a time table file identifying the one or more media segments, the one or more media files, or a combination thereof comprising the one or more concatenated media files. More specifically, the time table file generated by the media platform 109 comprises at least one start time and at least one end time for the one or more media segments, the one or more media files, or a combination thereof in the concatenated media file.

In one embodiment, the media platform 109 determines the duration of at least one buffer segment based on a media playback seek accuracy associated with the web client 103, one or more media plugins associated with the web client 103, one or more web applications being accessed by the web client 103, one or more websites being accessed by the web client 103, or a combination thereof. Moreover, the media platform 109 can also generate the at least one buffer segment with a constant duration (e.g., 250 ms or 500 ms), with a variable duration based on a function related to a playback position within the concatenated media file (e.g., a linear function or a logarithmic function), or a combination thereof. In addition, the media platform 109 can further differentiate the at least one buffer segment for respective ones of the one or more web applications, the one or more websites, or a combination thereof.

In one embodiment, from the client side perspective, the web client 103 determines a request to activate at least one media segment (e.g., an audio segment), at least one media file (e.g., an audio file), or a combination thereof associated with a web application (e.g., a navigation application), a website, or a combination thereof. By way of example, the web client 103 may request to activate at least one media segment associated with a web application in order for a user of a mobile device (e.g., a mobile phone) to hear as well as read instructions, directions, or a combination thereof associated with the web application. The web client 103 then utilizes this request to initiate a playback of the concatenated media file containing the at least one media segment. Next, the web client 103 immediately pauses the playback of the concatenated media file (i.e., before a user is able to hear a sound or view an image) so that the web client 103 can seek the start time of the requested media segment from the time table file associated with the concatenated media file. As a result of the initiation of the concatenated media file, the web client 103 can now playback one or more media segments, one or more media files, or a combination thereof in the concatenated media file associated with the web application based on the at least one start time and the at least one end time for the one or more media segments, one or more media files, or a combination thereof in the concatenated media file.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UEs 101 can support any type of interface to the user (such as “wearable” circuitry, etc.).

By way of example, the UE 101, the web client 103, the web server 107, and the media platform 109 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

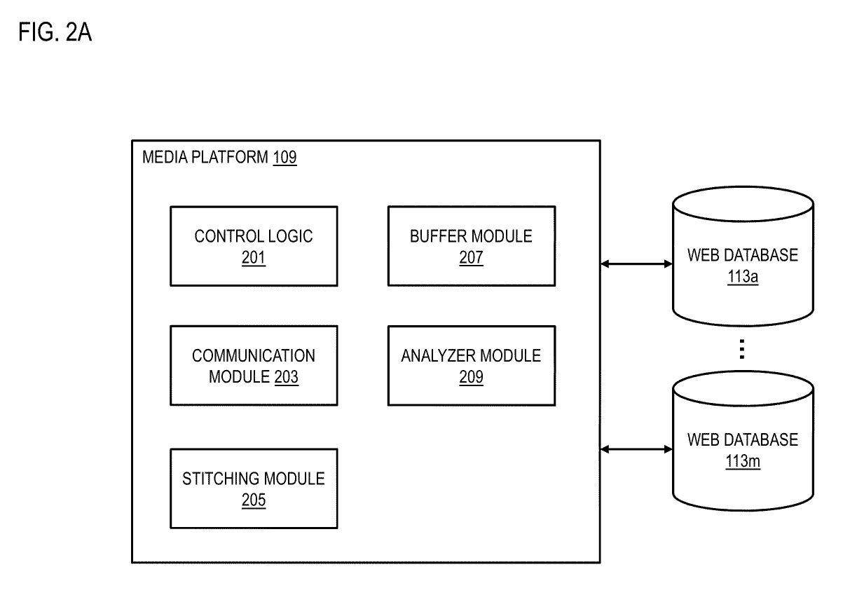

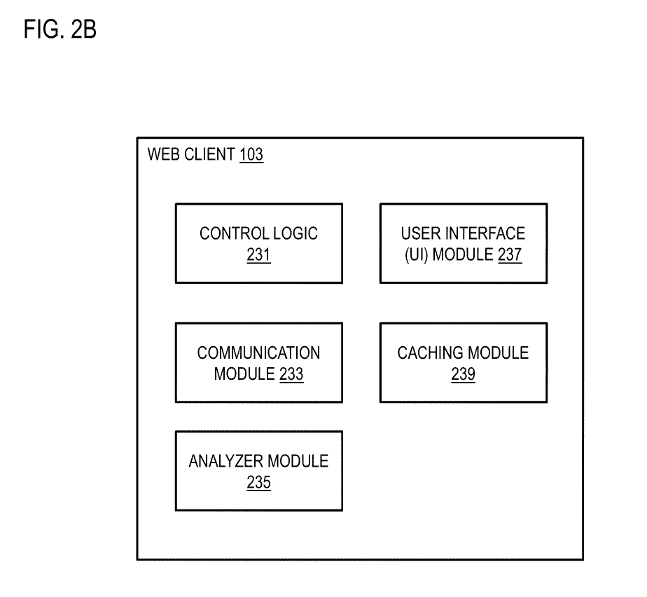

FIG. 2A is a diagram of the components of the media platform 109, according to one embodiment. By way of example, the media platform 109 includes one or more components for providing cross-platform audio guidance for web applications and websites. It is contemplated that the functions of these components may be combined in one or more components or performed by other components of equivalent functionality. In this embodiment, the media platform 109 includes a control logic 201, a communication module 203, a stitching module 205, a buffer module 207, and an analyzer module 209.

The control logic 201 oversees tasks, including tasks performed by the communication module 203, the stitching module 205, the buffer module 207, and the analyzer module 209. For example, although the other modules may perform the actual task, the control logic 201 may determine when and how those tasks are performed or otherwise direct the other modules to perform the task.

The communication module 203 is used for communication between the media platform 109, the web server 107, and the web client 103 of a UE 101. The communication module 203 may be used to communicate commands, requests, data, etc. For example, the communication module 203 may be used to determine one or more media segments (e.g., audio segments), one or more media files (e.g., audio files), or a combination thereof associated with one or more web applications, one or more websites, or a combination thereof. In one embodiment, the one or more media segments, the one or more media files, or a combination thereof associated with a web application, a website, or a combination may also be associated with the web databases 113. The communication module 203 may also be used to cause a loading of the stitching module 205 with the one or more media segments, the one or more media files, or a combination thereof associated a web application, a website, or a combination thereof. Moreover, the communication module 203 may further be used to cause a loading of the stitching module 205 with one or more buffer segments generated by the buffer module 207. In addition, the communication module may be used to cause a loading of the analyzer module 209 with one or more concatenated media files so that the analyzer module 209 can determine at least one start time and at least one end time for the one or more media segments, the one or more media files, or a combination thereof in the concatenated media file. The communication module 203 is also used to transmit the concatenated media file generated by the stitching module 205 and the respective time table file generated by the analyzer module 209 to a media client 103 of a UE 101 via the communication network 105.

The stitching module 205 is used to concatenate one or more media segments (e.g., an audio segment), one or more media files (e.g., an audio file), or a combination thereof associated with one or more web applications, one or more websites, or a combination thereof into at least one concatenated media file. By way of example, the one or more media segments, the one or more media files, or a combination thereof can comprise one or more auditory instructions or one or more parts of one or more auditory instructions. In addition, the one or more media segments, the one or more media files, or a combination thereof may comprise one or more seekable file formats (e.g., MP3, Ogg, WAV, AAC, etc.). The stitching module 205 is also used to insert at least one buffer segment (e.g., a period of silence or a period of blank video) generated by the buffer module 207 between the one or more media segments, the one or more media files, or a combination thereof.

The buffer module 207 is used to generate at least one buffer segment (e.g., a period of audio silence or a period of blank video) that is then inserted by the stitching module 205 between one or more media segments, one or more media files, or a combination thereof associated with one or more web applications, one or more websites, or a combination thereof. In one embodiment, the buffer module 207 determines the duration of the at least one buffer segment based on a media playback seek accuracy associated with a web client 103, one or more media plugins associated with the web client 103, a web application being accessed by the web client 103, a website being accessed by the web client 103, or a combination thereof. The buffer module 207 can also determine to generate the at least one buffer segment with a constant duration (e.g., 250 ms or 500 ms), with a variable duration based on a function related to a playback position within the concatenated file (e.g., a linear function or a logarithmic function), or a combination thereof. In one embodiment, the buffer module 207 can further differentiate the at least one buffer segment for respective ones of the one or more web applications, the one or more websites, or a combination thereof.

The analyzer module 209 is used to analyze one or more media segments, one or more media files, or a combination thereof concatenated in a concatenated media file to determine at least one start time and at least one end time for the one or more media segments, the one or more media files, or a combination thereof. The analyzer module 209 is also used to generate at least one time table file comprising the at least one start time and at least one end time for the one or more media segments, the one or more media files, or a combination thereof in the concatenated media file.

FIG. 2B is a diagram of the components of the web client 103, according to one embodiment. By way of example, the web client 103 includes one or more components for providing cross-platform audio guidance for web applications and websites. It is contemplated that the functions of these components may be combined in one or more components or performed by other components of equivalent functionality. In this embodiment, the media platform 109 includes a control logic 231, a communication module 233, an analyzer module 235, a user interface (UI) module 237, and a caching module 239.

Similar to the control logic 201 of the media platform 109, the control logic 231 oversees tasks, including tasks performed by the communication module 233, the analyzer module 235, the user interface module 237, and the caching module 239. For example, although the other modules may perform the actual task, the control logic 231 may determine when and how those tasks are performed or otherwise direct the other modules to perform the task.

Similar to the communication module 203 of the media platform 109, the communication module 233 is used for communication between the web client 103, the UE 101, and the media platform 109 of the web server 107. The communication module 233 may be used to communicate commands, requests, data, etc. For example, the communication module 233 may be used to cause the transmission of a request to access one or more web applications (e.g., a navigation application), one or more websites, or a combination thereof that are associated with one or more media segments (e.g., an audio segment), one or more media files (e.g., an audio file), or a combination thereof contained in one or more concatenated media files. The communication module 233, in connection with the user interface module 237, may also be used to present, render, and/or playback the one or more media segments, the one or more media files, or a combination thereof. In one embodiment, the communication module 233 may further be used to load the caching module 239 with one or more concatenated media files and respective time table files associated with one or more web applications, one or more websites, or a combination thereof.

Similar to the analyzer module 209 of the media platform 109, the analyzer 235 is used to determine at least one start time and at least one end time of one or more media segments, one or more media files, or a combination thereof based on the time table file related to one or more concatenated media files associated with one or more web applications, one or more websites, or a combination thereof. The analyzer module 235 then returns the at least one start time and at least one end time of the one or more media segments, the one or more media files, or a combination thereof to the communication module 233, which then transmits this information to the user interface module 237.

The user interface (UI) module 237 interacts with the media platform 109 in a client-server relationship to cause a presentation, a rendering, and/or a playback of one or more media segments, one or more media files, or a combination thereof associated with one or more web applications, one or more websites, or a combination thereof. In one embodiment, the user interface module 237 is used to activate and/or playback at least one media segment, at least one media file, or a combination thereof in a concatenated media file associated with the one or more web applications, the one or more websites, or a combination thereof. More specifically, the user interface module 237, in connection with the communication module 233, immediately pauses the playback of the concatenated media file (i.e., before a user is able to hear a sound or view an image) upon activation and/or or playback of the at least one media segment, at least one media file, or a combination thereof so that the user interface module 237, in connection with the analyzer module 235, can seek across the one or more media segments, the one or more media files, or a combination thereof based on at least one start time and at least one end time contained in the respective time table file. Based upon this single user interaction, the user interface module 237 can be used to playback multiple media segments, media files, or a combination thereof in the concatenated media file without requiring further user interaction.

In one embodiment, the caching module 239 temporarily caches the concatenated media file and respective time table file associated with at least one web application, at least one website, or a combination thereof so that the web client 103 does not have to re-request to activate the concatenated media file each time the web client 103 accesses the at least one web application, the at least one website, or a combination thereof.

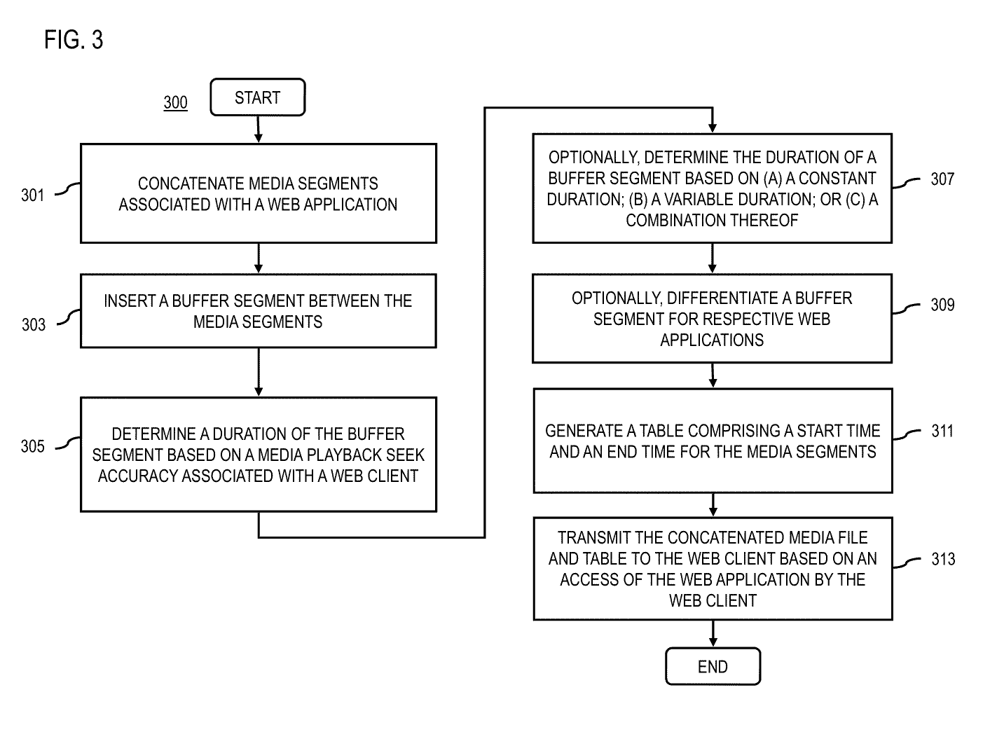

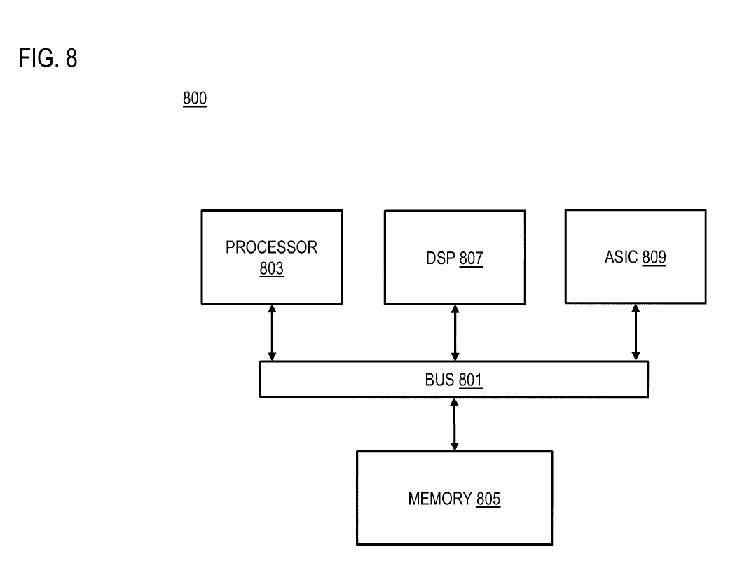

FIG. 3 is a flowchart of a server side process for providing cross-platform audio guidance for web applications and websites, according to one embodiment. In one embodiment, the media platform 109 performs the process 300 and is implemented in, for instance, a chip set including a processor and a memory as shown in FIG. 8. In step 301, the media platform 109 causes, at least in part, a concatenation of one or more media segments, one or more media files, or a combination thereof associated with one or more web applications, one or more websites, or a combination thereof into at least one concatenated media file. In one embodiment, the one or more media segments (e.g., an audio segment), the one or more media files (e.g., an audio file), or a combination thereof each comprise one auditory instruction or a part of an auditory instruction that is then concatenated (i.e., stitched) together by the media platform 109. Moreover, the one or more media segments, the one or more media files, or a combination thereof may comprise one or more seekable file formats (e.g., MP3, Ogg, WAV, AAC, etc.).

In step 303, the media platform 109 determines to insert at least one buffer segment between the one or more media segments, the one or more media files, or a combination thereof in the at least one concatenated media file. By way of example, the one or more buffer segments can include one or more periods of audio silence, one or more periods of blank video, or a combination thereof. In one embodiment, an operating system of a web client (e.g., ANDROID) can experience difficulties in seeking a specific location in a concatenated media file associated with a web application, a website, or a combination thereof. Therefore, the media platform 109 inserts one or more buffer segments between the one or more media segments, the one or more media files, or a combination thereof to better enable the web client to seek an exact location in the concatenated media file.

In step 305, the media platform 109 determines one or more durations of the at least one buffer segment based, at least in part, on a media playback seek accuracy associated with the web client, one or more media plugins associated with the web client, the at least one web application, the at least one website, or a combination thereof. By way of example, different web clients have different seek capabilities (e.g., ANDROID is less precise than iOS) and therefore exhibit different abilities to play specific media based on particular actions being performed. More specifically, the greater the inaccuracy associated with the seeking capabilities of a web client, the greater the likelihood that playing any portion of a media file by the web client may result in not hearing or seeing the intended portion of the media file. For example, seek accuracy associated with a web client is particularly relevant for games. As a result, the media platform 109 determines one or more durations of the at least one buffer segment based on the least accurate web client in the marketplace in order to ensure cross platform utilization.

In step 307, the media platform 109 optionally determines one or more durations of the at least one buffer segment based, at least in part, on (a) one or more constant durations; (b) one or more variable durations based, at least in part, on one or more functions related to a playback position within the at least one concatenated file; or (c) a combination thereof. By way of example, the media platform 109 can determine to generate the at least one buffer segment as a constant duration of 250 ms or 500 ms depending on the operating system and/or the requirements of a web application, a website, or a combination thereof. In addition, the media platform 109 can determine to generate the at least one buffer segments as a function of the position of the at least one buffer segment inside the concatenated media file (e.g., duration as a linear function or as a logarithmic function of the position).

In step 309, the media platform 109 further optionally causes, at least in part, a differentiation of the at least one buffer segment for respective ones of the one or more web applications, the one or more websites, or a combination thereof. By way of example, certain web applications (e.g., games) may require a high degree of seek accuracy in order to create realistic game play and therefore require a greater duration of the at least one buffer segment to ensure accurate playback of the concatenated media file associated with the particular web applications.

In step 311, the media platform 109 causes, at least in part, a generation of at least one table comprising at least one start time and at least one end time for the one or more media segments, the one or more media files, or a combination thereof in the at least one concatenated media file. In one embodiment, the at least one start time and at least one end time are required by a web client because the one or more media segments, the one or more media files, or a combination thereof are concatenated into a single media file and the at least one start time and at least one end time enable the web client to play a particular media segment, a particular media file, or a combination thereof at the appropriate time without having to play the whole concatenated media file. More specifically, the one or more media segments, the one or more media files, or a combination thereof are concatenated into a single media file because some mobile browsers (e.g., SAFARI on iOS) require a user interaction in order to activate each media file associated with a web application, a website, or a combination thereof. As a result, by concatenating the one or more media segments, the one or more media files, or a combination thereof, the web client can play any one of the media segments, any one of the media files, or a combination thereof based on a single user interaction.

In step 313, the media platform 109, causes, at least in part, a transmission of the at least one concatenated media file to a web client based, at least in part, on an access by the web client of the at least one web application, the at least one website, or a combination thereof. In addition, the media platform 109 also causes, at least in part, a transmission of the at least one table to the web client. By way of example, when a web client attempts to accesses a web application (e.g., a navigation application) that is associated with multiple media files (e.g., audio files), the media platform 109 can transmit a concatenated media file containing the multiple media files and the related time table file to the web client to enable a user to seamlessly experience the multiple media files regardless of the mobile browser or mobile platform utilized by the web client.

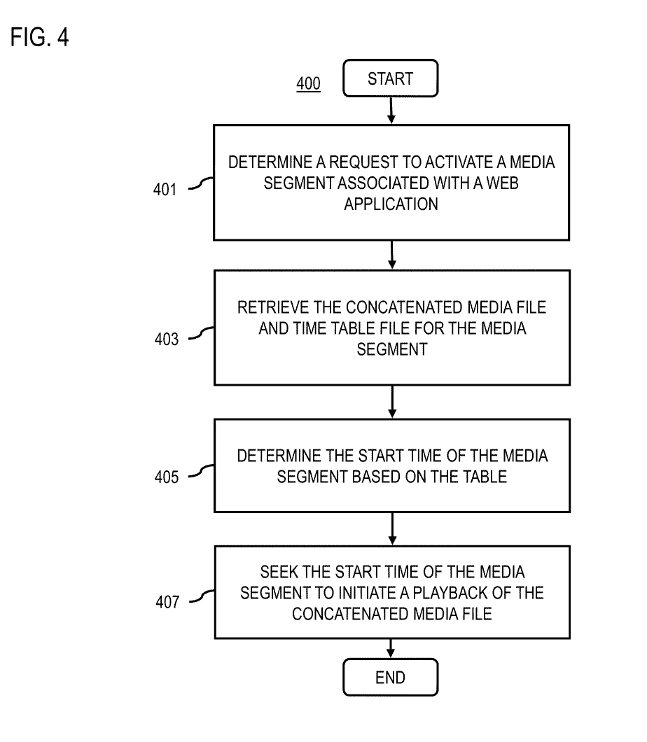

FIG. 4 is a flowchart of a client side process for providing cross-platform audio guidance for web applications and websites, according to one embodiment. In one embodiment, the web client 103 performs the process 400 and is implemented in, for instance, a chip set including a processor and a memory as shown in FIG. 8. In step 401, the web client 103 determines a request, at a web client, to activate at least one media segment associated with at least one web application, at least one website, or a combination thereof, wherein the at least one media segment is included in at least one concatenated media file that is a concatenation of the at least one media segment, one or more other media segments, one or more media files, or a combination thereof with one or more buffer segments separating the at least one media segment, the one or more other media segments, the one or more media files, or a combination thereof.

In one embodiment, once a web server concatenates the requisite one or more media segments, one or more media files, or a combination thereof into a concatenated media file with one or more buffer segments separating the one or more media segments, the one or more media files, or a combination thereof, the web client 103 is able to accurately playback any of the one or more media segments, the one or more media files, or a combination thereof based on the single request to activate the at least one media segment included in the concatenated media file. Moreover, in one embodiment, the one or more durations of the one or more buffer segments is based, at least in part, on a media playback seek accuracy associated with the web client, one or more media plugins associated with the web client, the at least one web application, the at least one website, or a combination thereof. As previously discussed, different web clients have different seek capabilities (e.g., ANDROID is less precise than iOS) and therefore exhibit different abilities to play specific media based on particular actions being performed. In addition, in one embodiment, the one or more buffer segments include, at least in part, one or more periods of audio silence, one or more periods of blank video, or a combination thereof. Also as previously discussed, the insertion of one or more periods of audio silence, one or more periods of blank video, or a combination thereof in between the one or more media segments, the one or more media files, or a combination thereof in the concatenated media file increases the playback seek accuracy of the web client 103 operating on one or more platforms.

In step 403, the web client 103 causes, at least in part, a retrieval of at least one table comprising at least one start time and at least one end time for the at least one media segment, the one or more other media segments, the one or more media files, or a combination thereof in the at least one concatenated media file. By way of example, because the one or more media segments, the one or more media files, or a combination thereof are concatenated together, the table comprising the at least one start time and at least one end time for the one or more media segments, the one or more media files, or a combination thereof enables the web client 103 to accurately seek and then playback any media segment, any media file, or a combination thereof associated with a web application, a website, or a combination thereof without having to play all of the media segments, all of the media files, or a combination thereof.

In step 405, the web client 103 determines the start time of the at least one media segment based, at least in part, on the at least one table. As previously discussed, in order for the web client 103 to accurately playback one or more media segments, one or more media files, or a combination thereof associated with one or more web applications, one or more websites, or a combination thereof, the web client 103 first needs to determine the start time of the requested media segment, the requested media file, or a combination thereof.

In step 407, the web client 103 causes, at least in part, a seeking to a start time of the at least one media segment in the at least one concatenated media file to initiate a playback of the at least one media segment. In one embodiment, once the web client 103 determines the start time of the requested media segment, the web client 103 can seek and then playback the requisite one or more media segments, one or more media files, or a combination thereof associated with a web application, a website, or a combination thereof.

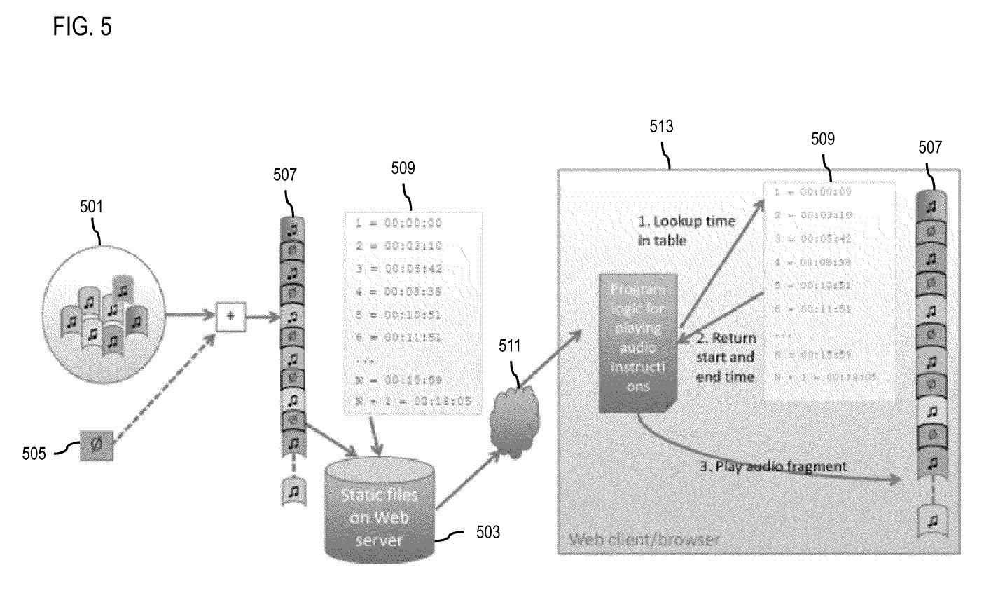

FIG. 5 is a diagram of an example data flow as utilized in the processes of FIGS. 3 and 4, according to various embodiments. As shown, FIG. 5 illustrates an embodiment of one or more media segments, one or more media files, or a combination thereof (i.e., one or more auditory instructions or one or more parts of one or more auditory instructions) associated with one or more web applications, one or more websites, or a combination thereof. By way of example, the one or more media segments, the one or more media files, or a combination thereof 501 are concatenated (i.e., stitched) by a web server 503 along with at least one buffer segment 505 between the one or more media segments, the one or more media files, or a combination thereof 501 in the at least one concatenated media file 507. The web server 503 then generates a time table file 509 comprising at least one start time and at least one end time for the one or more media segments, the one more media files, or a combination thereof 501 in the concatenated media file 507, which the web server 503 then transmits via a communication network 511 to a web client 513. The web client 513 then, based on a single user interaction, starts playing the concatenated media file 507, which the web client 513 the immediately pauses. Thereafter, the web client 513 is able to play one or more media segments, one or more media files, or a combination thereof 501 in the concatenated media file 507 based on the time table file 509 without further user interaction.

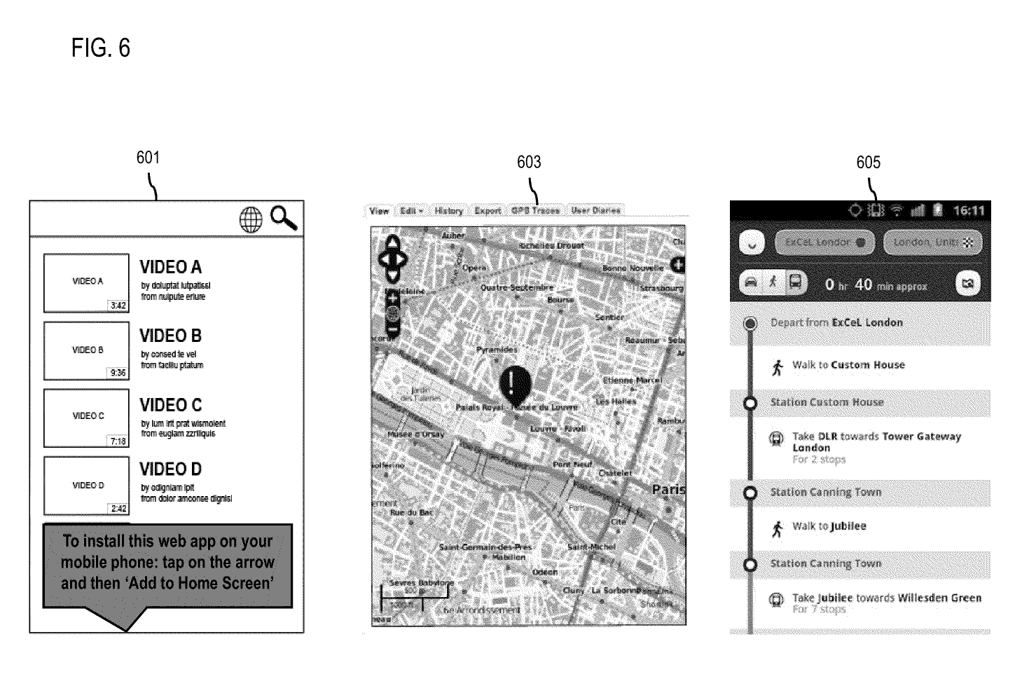

FIG. 6 is a diagram of user interfaces utilized in the processes of FIGS. 3 and 4, according to various embodiments. As shown, the example user interfaces of FIG. 6 include one or more user interface elements and/or functionalities created and/or modified based, at least in part, on information, data, and/or signals resulting from the processes (e.g., processes 300 and 400) described with respect to FIGS. 3 and 4. More specifically, FIG. 6 illustrates three user interfaces (e.g., interfaces 601, 603, and 605) depicting various embodiments. As shown in user interface 601, auditory tips within a web application can be utilized by a web client to explain to a user how an application works. Moreover, these auditory tips can be accompanied by visual tips. For example, in user interface 601, the user can see the tip “To install this web app on your mobile phone: tap on the arrow and then ‘Add to Home Screen,’” and can also automatically hear the audio guidance as soon as the visual tip appears. As shown in user interface 603, auditory feedback within a web application can be utilized by a web client to inform a user of his or her geographic location. For example, as depicted in user interface 603, the user will automatically hear when he or she is near an interesting location inside a web application (e.g., in this instance, the user could hear: “You are now near the Louvre”). As further shown in user interface 605, the auditory feedback based on location and routing with a web application can be utilized by a web client to inform a user when to make a change in direction. More specifically, as depicted in user interface 605, a user can automatically be notified with audio notifications in this web application that he or she needs to transfer from one transit line to another.

The processes described herein for providing cross-platform audio guidance for web applications and websites may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

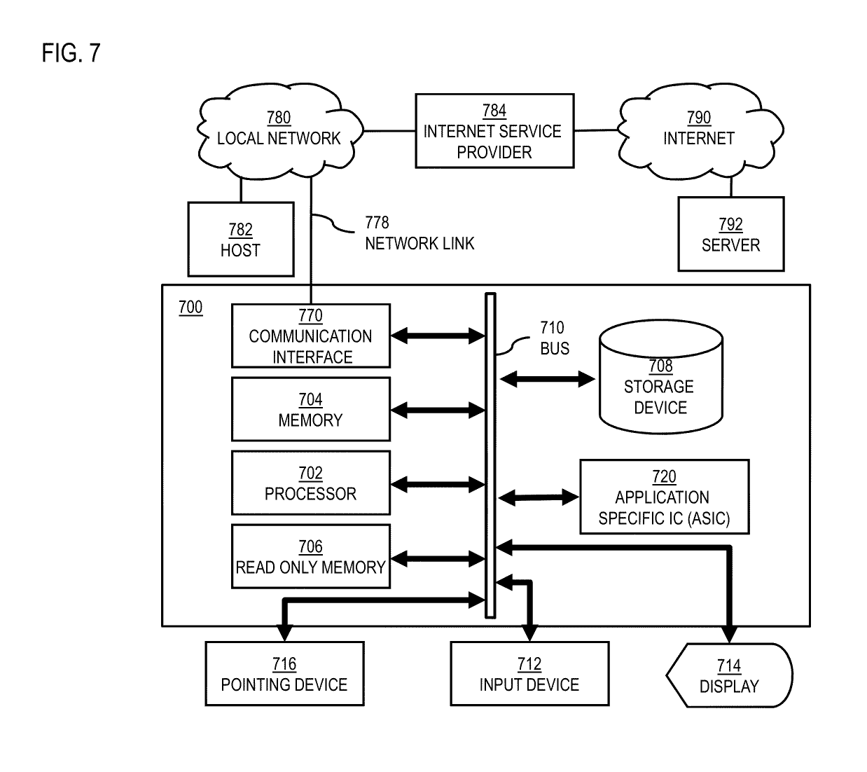

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to provide cross-platform audio guidance for web applications and websites as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of providing cross-platform audio guidance for web applications and websites.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to provide cross-platform audio guidance for web applications and websites. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for providing cross-platform audio guidance for web applications and websites. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for providing cross-platform audio guidance for web applications and websites, is provided to the bus 710 for use by the processor from an external input device 712, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for providing cross-platform audio guidance for web applications and websites to the UEs 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to provide cross-platform audio guidance for web applications and websites as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of providing cross-platform audio guidance for web applications and websites.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to provide cross-platform audio guidance for web applications and websites. The memory 805 also stores the data associated with or generated by the execution of the inventive steps.

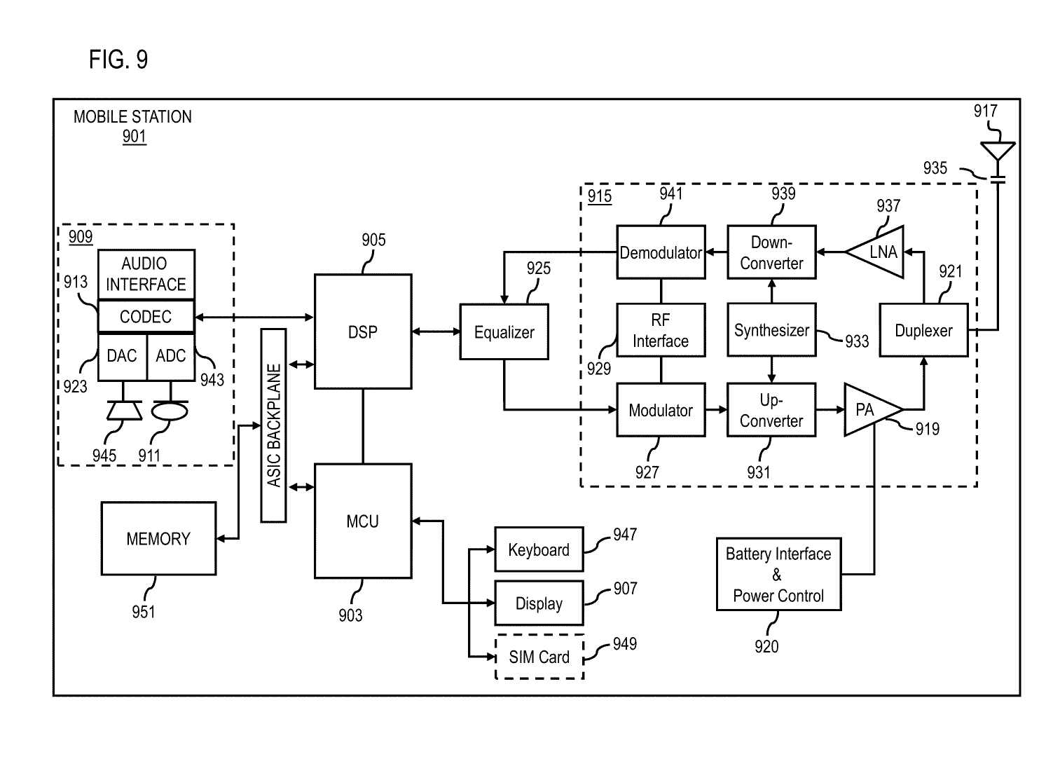

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of providing cross-platform audio guidance for web applications and websites. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of providing cross-platform audio guidance for web applications and websites. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to provide cross-platform audio guidance for web applications and websites. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a concatenation of one or more media segments, one or more media files, or a combination thereof associated with one or more web applications, one or more websites, or a combination thereof into at least one concatenated media file;
at least one determination to insert at least one buffer segment between the one or more media segments, the one or more media files, or a combination thereof in the at least one concatenated media file; and
a transmission of the at least one concatenated media file to a web client based, at least in part, on an access of the at least one web application, the at least one website, or a combination thereof.

2. A method of claim 1, wherein the (1) data and/or (2) information and/or (3) at least one signal are further based, at least in part, on the following:
at least one determination of one or more durations of the at least one buffer segment based, at least in part, on a media playback seek accuracy associated with the web client, one or more media plugins associated with the web client, the at least one web application, the at least one website, or a combination thereof.

3. A method of claim 1, wherein the (1) data and/or (2) information and/or (3) at least one signal are further based, at least in part, on the following:
at least one determination of one or more durations of the at least one buffer segment based, at least in part, on (a) one or more constant durations; (b) one or more variable durations based, at least in part, on one or more functions related to a playback position within the at least one concatenated file; or (c) a combination thereof.

4. A method of claim 1, wherein the (1) data and/or (2) information and/or (3) at least one signal are further based, at least in part, on the following:
a differentiation of the at least one buffer segment for respective ones of the one or more web applications, the one or more websites, or a combination thereof.

5. A method of claim 1, wherein the (1) data and/or (2) information and/or (3) at least one signal are further based, at least in part, on the following:
a generation of at least one table comprising at least one start time and at least one end time for the one or more media segments, the one or more media files, or a combination thereof in the at least one concatenated media file.

6. A method of claim 5, wherein the (1) data and/or (2) information and/or (3) at least one signal are further based, at least in part, on the following:
a transmission of the at least one table to the web client.

7. An apparatus comprising:
at least one processor; and
at least one memory including computer program code for one or more programs,
the at least one memory and the computer program code configured to, with the at least one processor, cause the apparatus to perform at least the following,
cause, at least in part, a concatenation of one or more media segments, one or more media files, or a combination thereof associated with one or more web applications, one or more websites, or a combination thereof into at least one concatenated media file;
determine to insert at least one buffer segment between the one or more media segments, the one or more media files, or a combination thereof in the at least one concatenated media file; and
cause, at least in part, a transmission of the at least one concatenated media file to a web client based, at least in part, on an access of the at least one web application, the at least one website, or a combination thereof.

8. An apparatus of claim 7, wherein the apparatus is further caused to:
determine one or more durations of the at least one buffer segment based, at least in part, on a media playback seek accuracy associated with the web client, one or more media plugins associated with the web client, the at least one web application, the at least one website, or a combination thereof.

9. An apparatus of claim 7, wherein the apparatus is further caused to:
determine one or more durations of the at least one buffer segment based, at least in part, on (a) one or more constant durations; (b) one or more variable durations based, at least in part, on one or more functions related to a playback position within the at least one concatenated file; or (c) a combination thereof.

10. An apparatus of claim 7, wherein the apparatus is further caused to:
cause, at least in part, a differentiation of the at least one buffer segment for respective ones of the one or more web applications, the one or more websites, or a combination thereof.

11. An apparatus of claim 7, wherein the apparatus is further caused to:
cause, at least in part, a generation of at least one table comprising at least one start time and at least one end time for the one or more media segments, the one or more media files, or a combination thereof in the at least one concatenated media file.

12. An apparatus of claim 11, wherein the apparatus is further caused to:
cause, at least in part, a transmission of the at least one table to the web client.

13. A method comprising facilitating a processing of and/or processing (1) data and/or (2) information and/or (3) at least one signal, the (1) data and/or (2) information and/or (3) at least one signal based, at least in part, on the following:
at least one determination of a request, at a web client, to activate at least one media segment associated with at least one web application, at least one website, or a combination thereof, wherein the at least one media segment is included in at least one concatenated media file that is a concatenation of the at least one media segment, one or more other media segments, one or more media files, or a combination thereof with one or more buffer segments separating the at least one media segment, the one or more other media segments, the one or more media files, or a combination thereof; and
a seeking to a start time of the at least one media segment in the at least one concatenated media file to initiate a playback of the at least one media segment.

14. A method of claim 13, wherein the (1) data and/or (2) information and/or (3) at least one signal are further based, at least in part, on the following:
a retrieval of at least one table comprising at least one start time and at least one end time for the at least one media segment, the one or more other media segments, the one or more media files, or a combination thereof in the at least one concatenated media file; and
at least one determination of the start time of the at least one media segment based, at least in part, on the at least one table.

15. A method of claim 13, wherein one or more durations of the one or more buffer segments is based, at least in part, on a media playback seek accuracy associated with the web client, one or more media plugins associated with the web client, the at least one web application, the at least one website, or a combination thereof.

16. A method of claim 13, wherein the one or more buffer segments include, at least in part, one or more periods of audio silence, one or more periods of blank video, or a combination thereof.

17. An apparatus comprising:
at least one processor; and
at least one memory including computer program code for one or more programs,
the at least one memory and the computer program code configured to, with the at least one processor, cause the apparatus to perform at least the following,
determine a request, at a web client, to activate at least one media segment associated with at least one web application, at least one website, or a combination thereof, wherein the at least one media segment is included in at least one concatenated media file that is a concatenation of the at least one media segment, one or more other media segments, one or more media files, or a combination thereof with one or more buffer segments separating the at least one media segment, the one or more other media segments, the one or more media files, or a combination thereof; and
cause, at least in part, a seeking to a start time of the at least one media segment in the at least one concatenated media file to initiate a playback of the at least one media segment.

18. An apparatus of claim 17, wherein the apparatus is further caused to:
cause, at least in part, a retrieval of at least one table comprising at least one start time and at least one end time for the at least one media segment, the one or more other media segments, the one or more media files, or a combination thereof in the at least one concatenated media file; and
determine the start time of the at least one media segment based, at least in part, on the at least one table.

19. An apparatus of claim 17, wherein one or more durations of the one or more buffer segments is based, at least in part, on a media playback seek accuracy associated with the web client, one or more media plugins associated with the web client, the at least one web application, the at least one website, or a combination thereof.

20. An apparatus of claim 17, wherein the one or more buffer segments include, at least in part, one or more periods of audio silence, one or more periods of blank video, or a combination thereof.

21-48. (canceled)
